(19) United States
(12) Patent Application Publication
(10) Pub. No.: US 2008/0171570 A1
(43) Pub. Date: Jul. 17, 2008

(54) WIRELESS COMMUNICATIONS SYSTEM IMPLEMENTING A PLURALITY OF WIRELESS COMMUNICATIONS SCHEMES WITH HANDOVER CAPABILITY

(76) Inventors: Akifumi Nagao, Osaka (JP); Masataka Irie, Osaka (JP); Satoshi Makimoto, Osaka (JP); Yukiyoshi Nagasawa, Kyoto (JP); Takeshi Hatakeyama, Osaka (JP)

Correspondence Address: MCDERMOTT WILL & EMERY LLP, 600 13TH STREET, NW, WASHINGTON, DC, 20005-3096, US

(21) Appl. No.: 11/968,936

(22) Filed: Jan. 3, 2008

(30) Foreign Application Priority Data
Jan. 12, 2007 (JP) 2007-004293

(51) Int. Cl. H04M 1/00

(52) U.S. Cl. 455/552.1

(57) ABSTRACT

A wireless communications system includes: a first communications processing section for implementing a dedicated communications function that is only for the first wireless communications scheme; a second communications processing section for implementing a dedicated communications function that is only for the second wireless communications scheme; a shared transceiver section shared by the first communications processing section and the second communications processing section; a scheme selection section for selectively inputting a signal from the first communications processing section or a signal from the second communications processing section to the shared transceiver section; and a communications switching control section for indicating, to the scheme selection section, a scheme to be selected. The communications switching control section determines a switching timing based on frame and sub-frame information from the first communications processing section in an operation of switching from the first wireless communications scheme to the second wireless communications scheme or an operation of searching for a communications target station using the second wireless communications scheme.

### CROSS REFERENCE TO RELATED APPLICATION

This application claims priority under 35 U.S.C. §119 on Patent Application No. 2007-4293 filed in Japan on Jan. 12, 2007 the entire contents of which are hereby incorporated by reference.

### BACKGROUND OF THE INVENTION

The present invention relates to a wireless communications system implementing a plurality of wireless communications schemes with handover capability.

A conventional mobile communications terminal may have two types of wireless communications means, i.e., cellular and wireless LAN, in which case the two communications means can be switched from one to another.

A cellular terminal can communicate with others while moving around at a high speed and over a wide area outside, but the transmission speed is as low as about 10 Mbps even with third-generation mobile telephones.

Wireless LAN is defined in the IEEE (Institute of Electrical and Electronics Engineers) 802.11 series, and is mainly used to connect to a network such as an intranet of a company or the Internet mainly via an access point provided in an office or at home. Normally, the range of communications of wireless LAN is smaller than that of cellular and is as small as about a few tens of meters. The communication speed of IEEE 802.11a and IEEE 802.11g is as high as 54 Mbps at maximum, while that of IEEE 802.11n, a next-generation wireless LAN standard, exceeds 100 Mbps.

With the IEEE 802.11 standard, there are two methods for determining whether a wireless LAN connection is available, i.e., one method in which the availability is determined by receiving a beacon signal transmitted from an access point, and another method in which a terminal transmits a probe request signal to an access point and receives a probe response signal being a response from the access point.

A mobile communications terminal, which has two types of wireless communications means, i.e., cellular and wireless LAN, is required to communicate by means of cellular which can be used while moving around when being outside, and to communicate by means of high-speed wireless LAN when wireless LAN can be used such as when being inside.

Patent Document 1 (Japanese Patent No. 3608503) discloses a method for switching between cellular communications means and wireless LAN communications means. The communications terminal device of Patent Document 1 is provided with separate wireless interfaces, one for cellular and another for wireless LAN, wherein the communications status of each wireless interface is monitored so that one wireless interface is switched to another when the quality of connection is expected to improve by doing so.

With the conventional method, however, two different wireless interfaces need to be provided separately for monitoring the statuses of the two types of wireless interfaces. Accommodating a plurality of different communications schemes as described above makes it difficult to reduce the size and cost of the communications device.

### SUMMARY OF THE INVENTION

It is an object of the present invention to provide a wireless communications system implementing a plurality of wireless communications schemes with handover capability, wherein it is possible to reduce the size and the cost of the system.

The present invention provides a communications system with two different wireless communications schemes, wherein sections implementing each communications scheme are classified into a section for the dedicated function and that for the common function, and the dedicated function sections of the communications schemes monitor each other, whereby it is possible to efficiently use the common function section by switching the use of the common function section between the communications schemes. This eliminates the need for providing separate wireless interfaces for the two schemes, and makes it possible to reduce the size and the cost of the system.

In order to achieve the object above, the present invention provides the following solutions.

A first solution is directed to a wireless communications system, in which some or all of a series of signal processing functions of an antenna, a high-frequency process and a modulation/demodulation process are shared between a first wireless communications scheme and a second wireless communications scheme, and a communications operation is performed by frames in the first wireless communications scheme, each frame being a collection of a plurality of sub-frames, the system including: a first communications processing section for implementing a dedicated communications function that is only for the first wireless communications scheme; a second communications processing section for implementing a dedicated communications function that is only for the second wireless communications scheme; a shared transceiver section shared by the first communications processing section and the second communications processing section; a scheme selection section for selectively inputting a signal from the first communications processing section or a signal from the second communications processing section to the shared transceiver section; and a communications switching control section for indicating, to the scheme selection section, a scheme to be selected, wherein the communications switching control section determines a switching timing based on frame and sub-frame information from the first communications processing section in an operation of switching from the first wireless communications scheme to the second wireless communications scheme or an operation of searching for a communications target station using the second wireless communications scheme.

In a second solution: the communications switching control section receives a frame start signal and a sub-frame start signal from the first communications processing section; when the frame start signal is received, the communications switching control section instructs the scheme selection section to select a signal from the first communications processing section; and when the sub-frame start signal is received n (n is a number greater than or equal to 0) times after receiving the frame start signal, the communications switching control section instructs the scheme selection section to select a signal from the second communications processing section, and when the sub-frame start signal is further received m (m is a number greater than or equal to 1) times after receiving the sub-frame start signal n times, the communications switching control section instructs the scheme selection section to select a signal from the first communications processing section.

In the first and second solutions, the shared transceiver section operates while switching between a signal from the first communications processing section and a signal from the second communications processing section based on the frame and sub-frame information from the first communications processing section. Therefore, the discontinuation of a communications operation by the first communications processing section is synchronized with a frame or a sub-frame, thereby reducing the frequency of communications errors of the first communications processing section relating to the switching timing.

In a third solution, the communications switching control section is such that values of n and m are fixed for all of the frame start signals.

In the third solution, the values of n and m, representing the switching control timing, are fixed through all frames, whereby the switching control is easy, and the control can be done with a small circuit scale.

In a fourth solution, the communications switching control section is such that a value of n is changed each time the frame start signal is received.

In the fourth solution, the value of n is varied. Therefore, even if the frame cycle of the first communications scheme and the communications data appearance timing of the second communications scheme are synchronized while being shifted from each other, the communications data appearance period in the second communications scheme and the period of switching the transceiver to the second communications processing section can be made to coincide with each other by shifting, for every frame, the timing at which the transceiver is switched to the second communications processing section.

In a fifth solution: the communications switching control section receives a frame start signal and a sub-frame start signal from the first communications processing section; when the frame start signal is received, the communications switching control section instructs the scheme selection section to select a signal from the first communications processing section; when the sub-frame start signal is received n (n is a number greater than or equal to 0) times after receiving the frame start signal, the communications switching control section instructs the scheme selection section to select a signal from the second communications processing section; each time the sub-frame start signal is received p (p is a number greater than or equal to 0) times after instructing the scheme selection section to select a signal from the second communications processing section, the communications switching control section repeatedly instructs the scheme selection section to select a signal from the second communications processing section; and when the sub-frame start signal is received m times after instructing the scheme selection section to select a signal from the second communications processing section, the communications switching control section instructs the scheme selection section to select a signal from the first communications processing section. Thus, a signal from the second communications processing section is selected by the scheme selection section one or more times within a frame.

In the fifth solution, the switching of the transceiver can be done a plurality of times within a frame, whereby the total amount of time over which the second communications processing section is being selected increases, thus increasing the communications opportunities by the second communications processing section.

In a sixth solution the communications switching control section receives, from the second communications processing section, time information representing an amount of time required for communications by the second communications processing section, and sets a value of m to be greater than the time information.

In the sixth solution, the amount of time required for a communications operation by the second communications processing section is requested, and the transceiver section is used for the communications operation by the second communications processing section over a period of time longer than the requested amount of time, whereby it is possible to ensure that the second communications processing section completes its communications operation, thus improving the communications efficiency.

In a seventh solution: the communications switching control section receives, from the second communications processing section, a signal indicating that a communications operation by the second communications processing section has been completed; and when a communications operation by the second communications processing section has been completed, the communications switching control section instructs the scheme selection section to stop selecting a signal from the second communications processing section and to select a signal from the first communications processing section.

In the seventh solution, the completion of the process by the second communications processing section is notified to the communications switching control section, whereby the operation can be switched to the first communications processing section at an earlier timing than scheduled by the communications switching processing section. Therefore, it is possible to reduce the amount of time over which the transceiver is used wastefully, whereby it is possible to suppress the decrease in the communications efficiency in the first communications processing section.

In an eighth solution: the communications switching control section is capable of instructing the scheme selection section independently for reception and for transmission; and if the second communications processing section is to perform only a receiving operation, the communications switching control section instructs the scheme selection section to select the second communications processing section only for a receiving side and select the first communications processing section for a transmitting side.

In the eighth solution, the transceiver is switched independently for reception and for transmission. Therefore, in a case where the second communications processing section does not transmit data, the transmitting side of the transceiver section can be made available for use by the first communications processing section even during a period of time in which the transceiver section is scheduled for use by the second communications processing section, thus suppressing the decrease in the communications efficiency in the first communications processing section.

A ninth solution is directed to a wireless communications system, in which some or all of a series of signal processing functions of an antenna, a high-frequency process and a modulation/demodulation process are shared between a first wireless communications scheme and a second wireless communications scheme, and a communications operation is performed by frames in the first wireless communications scheme, each frame being a collection of a plurality of sub-frames, the system including: a first communications processing section for implementing a dedicated communications function that is only for the first wireless communications scheme; a second communications processing section for implementing a dedicated communications function that is only for the second wireless communications scheme; a shared transceiver section shared by the first communications processing section and the second communications processing section; a scheme selection section for selectively inputting a signal from the first communications processing section or a signal from the second communications processing section to the shared transceiver section; and a communications switching control section for indicating, to the scheme selection section, a scheme to be selected. The communications switching control section determines a switching timing based on frame and sub-frame information from the first communications processing section and schedule information sent from a communications base station of the first communications processing section in an operation of switching from the first wireless communications scheme to the second wireless communications scheme or an operation of searching for a communications target station using the second wireless communications scheme.

In a tenth solution: the communications switching control section receives a frame start signal and a sub-frame start signal from the first communications processing section; when the frame start signal is received, the communications switching control section instructs the scheme selection section to select a signal from the first communications processing section; and when the sub-frame start signal is received n (n is a number greater than or equal to 0) times after receiving the frame start signal, the communications switching control section instructs the scheme selection section to select a signal from the second communications processing section, and when the sub-frame start signal is further received m (m is a number greater than or equal to 1) times after receiving the sub-frame start signal n times, the communications switching control section instructs the scheme selection section to select a signal from the first communications processing section. The position of the sub-frame including the schedule information is notified in advance, and the values of n and m are determined so as not to include the sub-frame including the schedule information.

In an eleventh solution, based on the schedule information, the communications switching control section determines values of n and m to be values other than a timing of a communications operation using the first communications processing section.

In the ninth, tenth and eleventh solutions, in the first communications scheme, the schedule information is shared with the communications base station, whereby it is possible to know sub-frames in a frame containing data that the first communications processing section needs to receive and sub-frames in a frame where the first communications processing section needs to transmit data. Therefore, periods other than those sub-frames in which the first communications processing section performs a communications operation can be assigned to the second communications processing section, thus suppressing the decrease in the communications efficiency in the first communications processing section.

In a twelfth solution, based on the schedule information, the communications switching control section determines values of n and m to be values other than a timing of communicating real-time data using the first communications processing section.

In the twelfth solution, the first communications processing section uses the transceiver only in sub-frames containing schedule information therein and in sub-frames containing real-time data therein, thus minimizing the period of time assigned to the first communications processing section and accordingly increasing the assignment to the second communications processing section, thereby increasing the communications opportunities by the second communications processing section.

In a thirteenth solution: the communications switching control section is capable of instructing the scheme selection section independently for reception and for transmission; and if the second communications processing section is to perform only a receiving operation, the communications switching control section instructs the scheme selection section to select the second communications processing section only for a receiving side and select the first communications processing section for a transmitting side.

In the thirteenth solution, the transceiver is switched independently for reception and for transmission. Therefore, in a case where the second communications processing section does not transmit data, the transmitting side of the transceiver section can be made available for use by the first communications processing section even during a period of time in which the transceiver section is scheduled for use by the second communications processing section, thus suppressing the decrease in the communications efficiency in the first communications processing section.

In a fourteenth solution: the communications switching control section is capable of instructing the scheme selection section independently for reception and for transmission; and based on the schedule information, the communications switching control section instructs the scheme selection section to select the second communications processing section only for a receiving side, irrespective of the values of n and m, at a timing at which a receiving operation is not performed by using the first communications processing section.

In the fourteenth solution, when the first communications processing section is not receiving data, the receiving side of the transceiver section can be switched to the second communications processing section, thus increasing the period of time over which the second communications processing section can receive data, thereby increasing the communications opportunities in a case where the second communications processing section only receives data.

In a fifteenth solution, the system further includes a schedule requesting section for requesting a communications base station of the first communications processing section for a schedule of temporarily discontinuing a communications operation using the first communications processing section, if a communications operation by the second communications processing section is needed.

In the fifteenth solution, if there is a communications request by the second communications processing section, the transceiver section is switched to the second communications processing section after making an agreement with the communications base station of the first communications processing section for temporarily discontinuing the communications operation by the first communications processing section, thereby eliminating communications errors of the first communications processing section relating to the transceiver switching.

In a sixteenth solution, the real-time data is sound data or video data.

### BRIEF DESCRIPTION OF THE DRAWINGS

FIG. 1 is a block diagram showing a configuration of a wireless communications system according to Embodiment 1 of the present invention.

FIG. 2 is a diagram showing the relationship between frames and sub-frames in a cellular communications scheme.

FIG. 3 is a diagram illustrating a basic operation of the wireless communications system according to Embodiment 1 of the present invention.

FIG. 4 is a diagram illustrating an operation of the wireless communications system according to Embodiment 1 of the present invention.

FIG. 5 is a diagram illustrating an operation of the wireless communications system according to Embodiment 1 of the present invention.

FIG. 6 is a diagram illustrating an operation of the wireless communications system according to Embodiment1 of the present invention.

FIG. 7 is a block diagram showing a configuration of a wireless communications system according to Embodiment 2 of the present invention.

FIG. 8 is a diagram illustrating an operation of the wireless communications system according to Embodiment 2 of the present invention.

FIG. 9 is a block diagram showing a configuration of a wireless communications system according to Embodiment 3 of the present invention.

FIG. 10 is a diagram illustrating an operation of the wireless communications system according to Embodiment 3 of the present invention.

FIG. 11 is a block diagram showing a configuration of a wireless communications system according to Embodiment 4 of the present invention.

FIG. 12 is a diagram illustrating an operation of the wireless communications system according to Embodiment 4 of the present invention.

FIG. 13 is a diagram illustrating an operation of the wireless communications system according to Embodiment 4 of the present invention.

FIG. 14 is a diagram illustrating an operation of the wireless communications system according to Embodiment 4 of the present invention.

FIG. 15 is a block diagram showing a configuration of a wireless communications system according to Embodiment 5 of the present invention.

FIG. 16 is a diagram illustrating an operation of the wireless communications system according to Embodiment 5 of the present invention.

FIG. 17 is a diagram illustrating an operation of the wireless communications system according to Embodiment 5 of the present invention.

FIG. 18 is a block diagram showing a configuration of a wireless communications system according to Embodiment 6 of the present invention.

FIG. 19 is a diagram illustrating an operation of the wireless communications system according to Embodiment 6 of the present invention.

FIG. 20 is a diagram showing an example of a range of elements of a wireless communications system of the present invention that can be implemented as an integrated circuit.

FIG. 21 is a diagram showing an example of a range of elements of a wireless communications system of the present invention that can be implemented as an integrated circuit.

FIG. 22 is a diagram showing an example of a range of elements of a wireless communications system of the present invention that can be implemented as an integrated circuit.

### DESCRIPTION OF THE PREFERRED EMBODIMENTS

### Embodiment 1

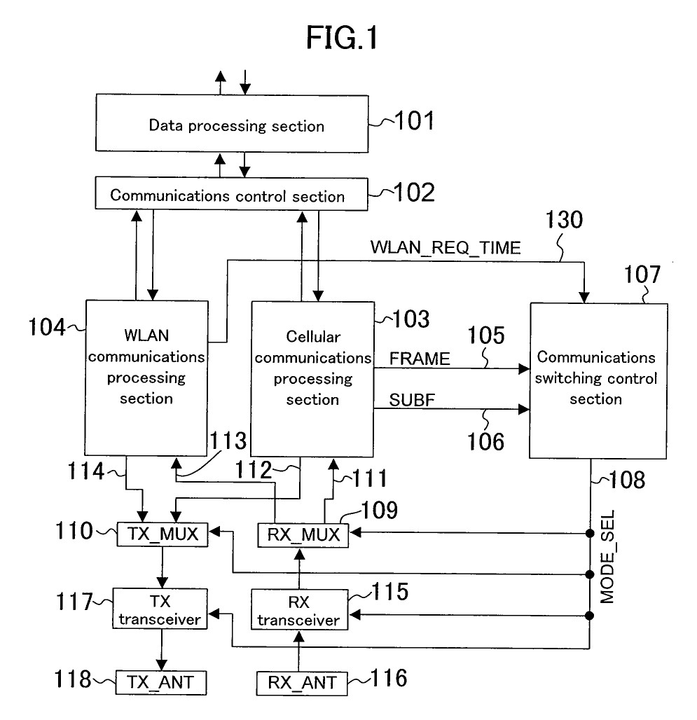

FIG. 1 is a block diagram showing a configuration of a wireless communications system according to Embodiment 1 of the present invention.

In the wireless communications system of FIG. 1, a data processing section 101 performs a data process, an IP (internet protocol) process, etc., for enabling the exchange of the communications data with applications.

A communications control section 102 exchanges data between one of communications processing sections 103 and 104 of which the communications scheme is being currently selected and the data processing section 101. Herein, two types of communications schemes can be selected, i.e., the cellular scheme capable of communications even under moving environments, and the wireless LAN scheme capable of high-speed communications under stationary environments.

The cellular communications processing section 103 has a function of converting and modulating data input from the communications control section 102 according to the cellular communications scheme, and a function of demodulating and converting data received in the cellular communications scheme to output the demodulated data to the communications control section 102.

The wireless LAN communications processing section (hereinafter “WLAN communications processing section) 104 has a function of converting and modulating data input from the communications control section 102 according to the wireless LAN communications scheme, and a function of demodulating and converting data received in the wireless LAN communications scheme to output the demodulated data to the communications control section 102.

A frame start signal (hereinafter, “FRAME”) 105 represents the beginning of a frame to be used in cellular communications, and is output from the cellular communications processing section 103. A sub-frame start signal (hereinafter, “SUBF”) 106 represents the beginning of a sub-frame to be used in cellular communications, and is output from the cellular communications processing section 103.

A communications switching control section 107 controls the switching between the communications schemes. Reference numeral 108 denotes a signal for switching between the communications schemes (hereinafter, “MODE_SEL”) whose timing is controlled by the communications switching control section 107.

A receiving scheme selection section (hereinafter, “RX_MUX”) 109 selectively outputs the received data to the cellular communications processing section 103 or the WLAN communications processing section 104 as indicated by MODE_SEL 108. A transmitting scheme selection section (hereinafter, “TX_MUX”) 110 selectively transmits transmit data 112 from the cellular communications processing section 103 or transmit data 114 from the WLAN communications processing section 104 as indicated by MODE_SEL 108. Cellular receive data 111 is output from RX_MUX 109, and input to the cellular communications processing section 103. The cellular transmit data 112 is output from the cellular communications processing section 103, and input to TX_MUX 110. Wireless LAN receive data 113 is output from RX_MUX 109, and input to the WLAN communications processing section 104. The wireless LAN transmit data 114 is output from the WLAN communications processing section 104, and input to TX_MUX 110.

Reference numeral 115 denotes a receiving transceiver (hereinafter, “RX transceiver”) whose operation mode can be changed, and the receiving transceiver 115 receives a cellular or wireless LAN high-frequency signal as indicated by MODE_SEL 108. Reference numeral 116 is a receiving antenna (hereinafter, “RX_ANT”).

Reference numeral 117 denotes a transmitting transceiver (hereinafter, “TX transceiver”), and transmitting transceiver 117 converts the input signal from TX_MUX 110 to a cellular or wireless LAN high-frequency signal as indicated by MODE_SEL 108 to transmit the converted signal. Reference numeral 118 denotes a transmitting antenna (hereinafter, “TX_ANT”).

Reference numeral 130 denotes a wireless LAN communications time request signal (hereinafter, “WLAN_REQ_TIME”), indicating the amount of communications time to be required by the WLAN communications processing section 104 for the next wireless LAN communications operation.

FRAME 105 outputs a HIGH pulse at the beginning of each frame. SUBF 106 outputs a HIGH pulse at the beginning of each sub-frame.

The communications switching control section 107 outputs LOW to MODE_SEL 108 when activating cellular communications, and HIGH to MODE_SEL 108 when activating wireless LAN communications.

RX_MUX 109 outputs data from the RX transceiver 115 to the cellular receive data 111 when MODE_SEL 108 is LOW, and outputs data from the RX transceiver 115 to the wireless LAN receive data 113 when MODE_SEL 108 is HIGH.

The RX transceiver 115 receives signals at a high frequency for cellular when MODE_SEL 108 is LOW, and receives signals at a high frequency for wireless LAN when MODE_SEL 108 is HIGH.

TX_MUX 110 selectively outputs the cellular transmit data 112 to the TX transceiver 117 when MODE_SEL 108 is LOW, and selectively outputs the wireless LAN transmit data 114 to the TX transceiver 117 when MODE_SEL 108 is HIGH.

The TX transceiver 117 transmits signals at a high frequency for cellular when MODE_SEL 108 is LOW, and transmits signals at a high frequency for wireless LAN when MODE_SEL 108 is HIGH.

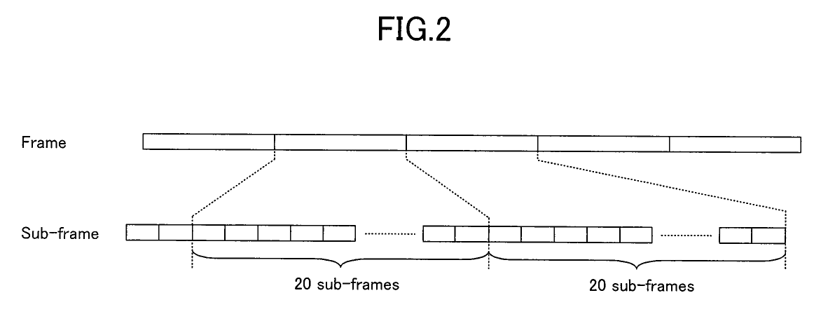

FIG. 2 shows an example of the relationship between frames and sub-frames in a cellular communications scheme contemplated in the present embodiment. Herein, each frame includes 20 sub-frames, and all frames have the same structure and are continuous with one another. It is assumed herein that the frame start time, the sub-frame start time, and the number of sub-frames per frame are agreed upon in advance with the communications base station of the cellular communications processing section 103. The length of a sub-frame is 0.5 ms, and that of a frame is 10 ms (=0.5 ms×20).

Next, an operation of a wireless communications system having such a configuration will be described. The subsequent operation-related descriptions are all directed to an operation when starting a communications operation for searching for a communications target station in the wireless LAN scheme while communicating in the cellular communications scheme, or a communications process in the wireless LAN scheme that entails switching from the cellular communications scheme to the wireless LAN scheme.

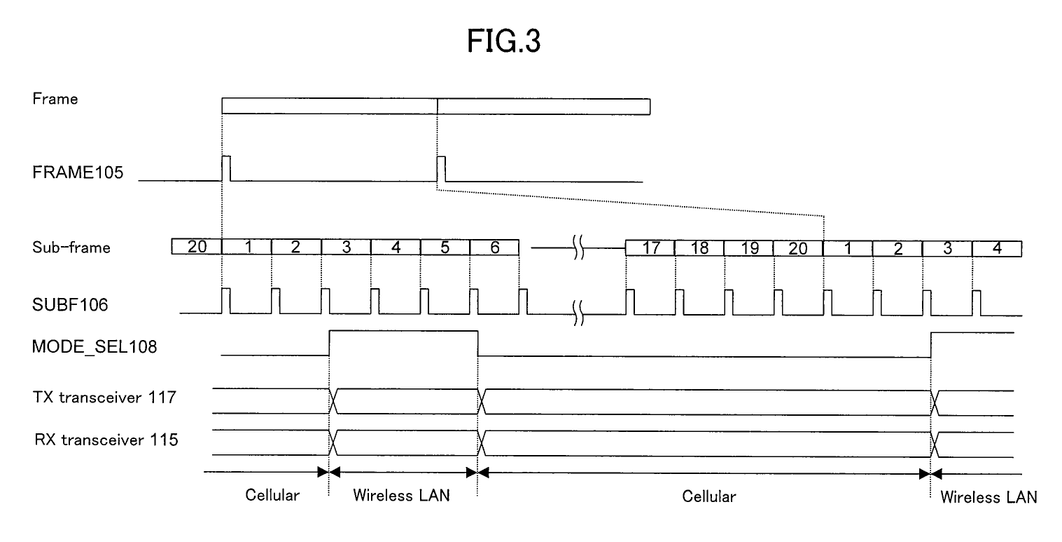

FIG. 3 is a timing diagram illustrating a basic operation of Embodiment 1. In the figure, sub-frames are numbered. Note that a frame includes 20 sub-frames, which are received successively, from the first sub-frame to the twentieth sub-frame. The pulse of FRAME 105 is output at the beginning of each frame. The pulse of SUBF 106 is output at the beginning of each sub-frame of each frame. MODE_SEL 108 is HIGH during sub-frames 3, 4 and 5, and is LOW otherwise. Then, the TX transceiver 117 and the RX transceiver 115 select the cellular communications scheme during sub-frames 1, 2 and 6-20, and select the wireless LAN communications scheme during sub-frames 3, 4 and 5.

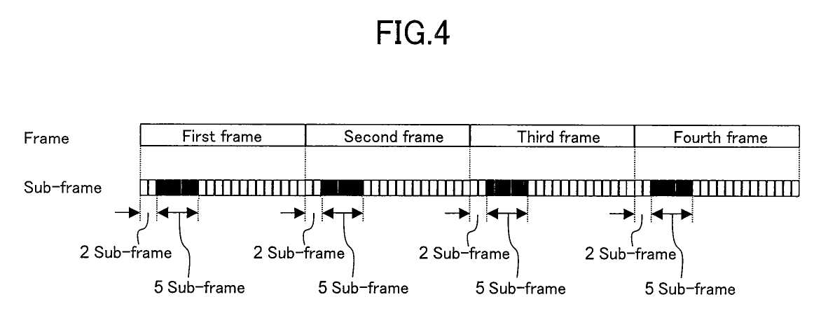

FIGS. 4, 5 and 6 are diagrams illustrating how the communications switching control section 107 controls MODE_SEL 108. In the figure, each square represents a sub-frame, wherein an open square indicates that the cellular communications scheme is selected for that sub-frame, and a solid square indicates that the wireless LAN communications scheme is selected for that sub-frame.

FIG. 4 is a diagram illustrating an operation where the communications switching control section 107 switches between wireless LAN and cellular at fixed timings independent of frames. This corresponds to the third solution set forth above, wherein n=2 and m=5. In the illustrated example, the communications scheme is switched to wireless LAN for 5 sub-frames starting from the third sub-frame.

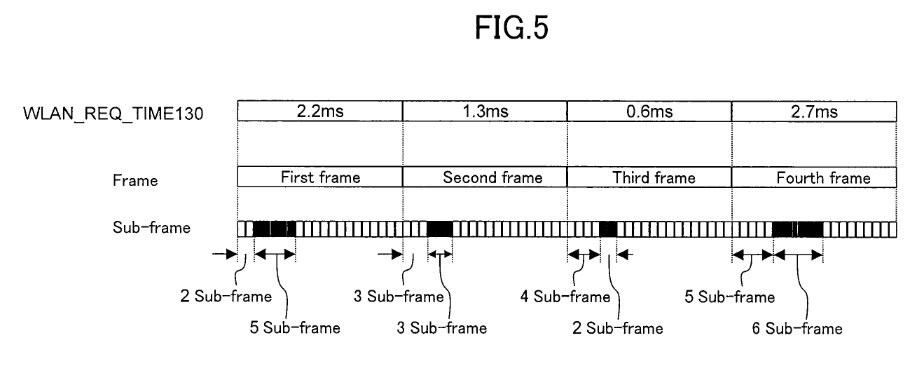

FIG. 5 shows an operation where the communications switching control section 107 simultaneously performs a switching control such that the timing at which to switch to wireless LAN is shifted from one frame to another and a control based on WLAN_REQ_TIME 130 from the WLAN communications processing section 104. The conversion from WLAN_REQ_TIME 130 to the number of sub-frames can be done by dividing WLAN_REQ_TIME 130 by 0.5 ms, or the length of a sub-frame, and rounding up the result to the nearest whole number. In the illustrated example, the value of n, representing the timing at which to switch to wireless LAN is incremented by one every frame. In the first frame, n=2, and therefore the scheme is switched to wireless LAN, starting from the third sub-frame. Moreover, since WLAN_REQ_TIME 130 is 2.2 ms, m=5, whereby wireless LAN remains selected for 5 sub-frames. In the second frame, n=3, and therefore the scheme is switched to wireless LAN, starting from the fourth sub-frame. Moreover, since WLAN_REQ_TIME 130 is 1.3 ms, m=3, whereby wireless LAN remains selected for 3 sub-frames. In the third frame, n=4, and therefore the scheme is switched to wireless LAN, starting from the fifth sub-frame. Moreover, since WLAN_REQ_TIME 130 is 0.6 ms, m=2, whereby wireless LAN remains selected for 2 sub-frames. In the fourth frame, n=5, and therefore the scheme is switched to wireless LAN, starting from the sixth sub-frame. Moreover, since WLAN_REQ_TIME 130 is 2.7 ms, m=6, whereby wireless LAN remains selected for 6 sub-frames. Thus, the RX transceiver 115 and the TX transceiver 117 can be shared between cellular and wireless LAN.

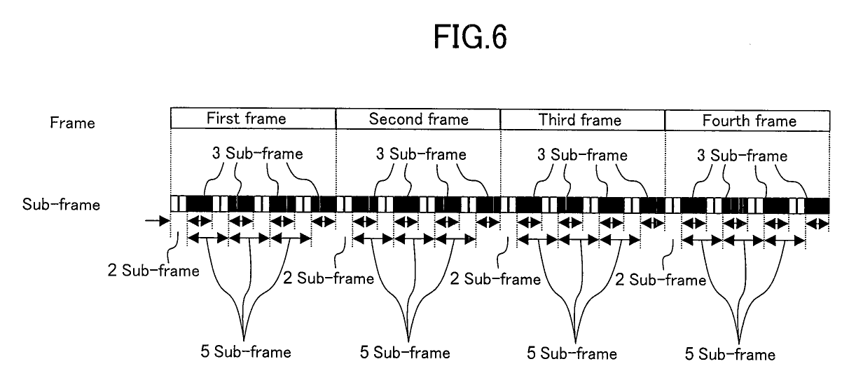

FIG. 6 is a diagram illustrating an operation where the communications switching control section 107 switches to wireless LAN a plurality of times within a frame. This corresponds to the fifth solution set forth above, wherein n=2, m=3 and p=5. In the illustrated example, the scheme is switched to wireless LAN, starting from the third sub-frame from the beginning of each frame, and wireless LAN remains selected for 3 sub-frames after the switching. Where p=5, the scheme is switched again to wireless LAN 5 sub-frames after the switching to wireless LAN. Specifically, wireless LAN is selected for 3 sub-frames and cellular is then selected for 2 sub-frames, after which wireless LAN is selected again. This operation is repeated every frame. Thus, the RX transceiver 115 and the TX transceiver 117 can be shared between cellular and wireless LAN.

### Embodiment 2

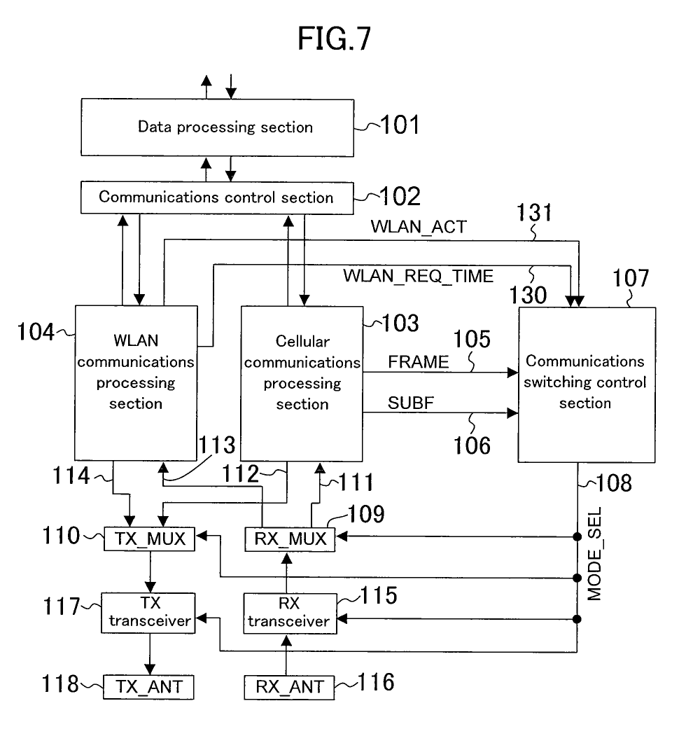

FIG. 7 is a block diagram showing a configuration of a wireless communications system according to Embodiment 2 of the present invention. This block diagram is similar to that of FIG. 1 except that a wireless LAN communications operation signal (hereinafter, “WLAN_ACT”) 131 is added. WLAN_ACT 131 is a signal indicating that wireless LAN is in a transmitting/receiving operation. WLAN_ACT 131 is HIGH while wireless LAN is in a communications operation, and is LOW while wireless LAN is not in a communications operation. With a series of communications operations such as where an acknowledge signal is received after completion of transmission, this signal is HIGH throughout all the periods of transmission, reception stand-by and reception.

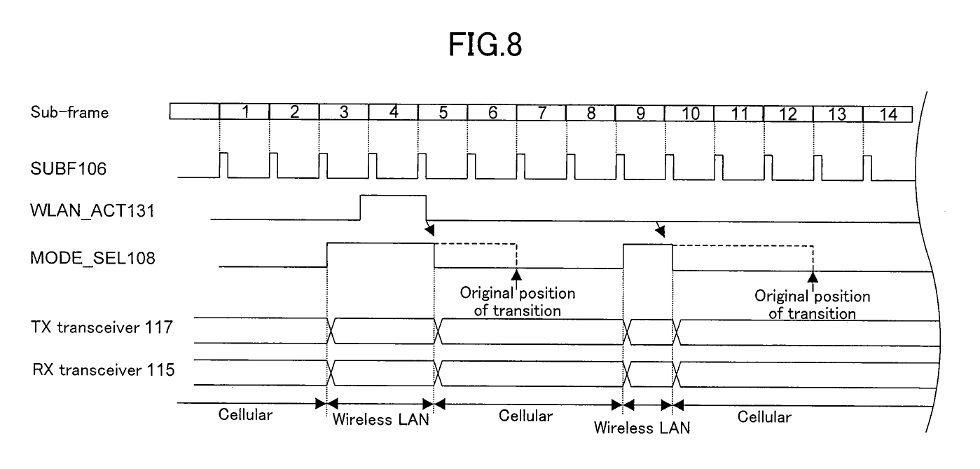

The operation of the wireless communications system having such a configuration will be described with reference to FIG. 8. In the figure, sub-frames are numbered. Note that a frame includes 20 sub-frames, which are received successively, from the first sub-frame to the twentieth sub-frame. The communications switching control section 107 performs an operation of the seventh solution as set forth above, wherein n=2, m=4 and p=6. In a state where WLAN_ACT 131 is not implemented, the timing at which to switch from wireless LAN to cellular is the position indicated by a dotted line in MODE_SEL 108 in FIG. 8 (the original position of transition) as discussed with reference to FIG. 6 in Embodiment 1. However, as WLAN_ACT 131 is implemented, the position at which the operation of wireless LAN is completed can be known, and therefore the operation of MODE_SEL 108 is moved to the position indicated by a solid line. Thus, the RX transceiver 115 and the TX transceiver 117 can be shared between cellular and wireless LAN.

### Embodiment 3

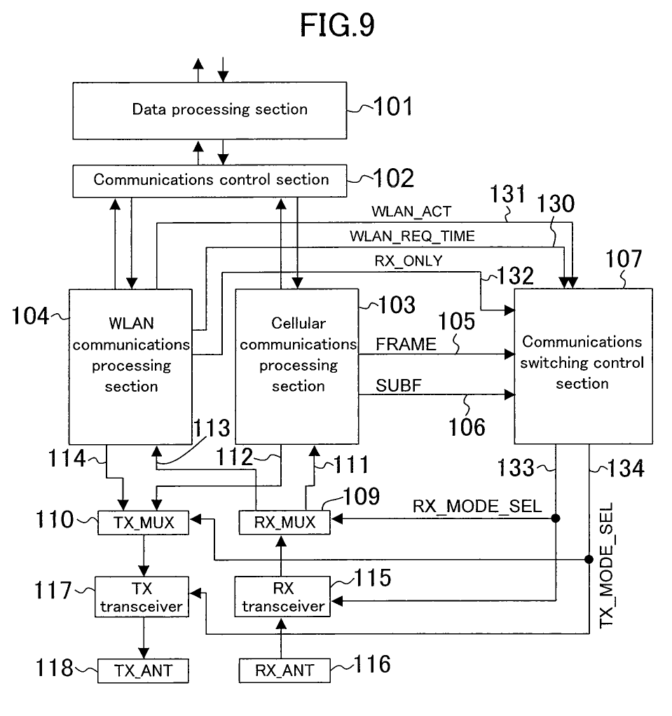

FIG. 9 is a block diagram showing a configuration of a wireless communications system according to Embodiment 3 of the present invention. In this figure, reference numeral 132 denotes a signal indicating that wireless LAN is only requesting the receiving operation (hereinafter, “RX_ONLY”). Reference numeral 133 denotes a transmission scheme switching signal of the receiving side (hereinafter, “RX_MODE_SEL”). Reference numeral 134 denotes a transmission scheme switching signal of the transmitting side (hereinafter, “TX_MODE_SEL”). FIG. 9 is similar to the block diagram of FIG. 7, except that RX_ONLY 132, RX_MODE_SEL 133 and TX_MODE_SEL 134 are added and MODE_SEL 108 is deleted.

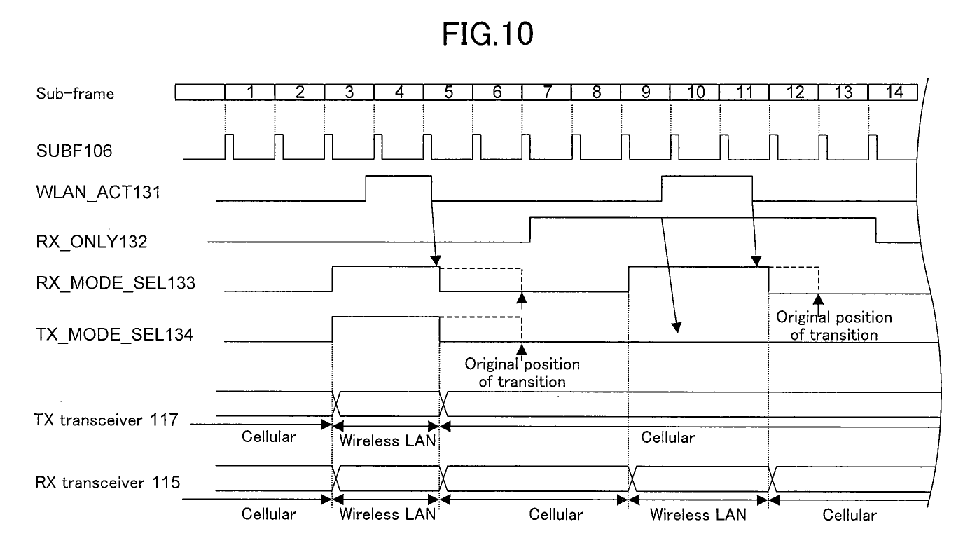

The operation of the wireless communications system having such a configuration will be described with reference to FIG. 10. In the figure, sub-frames are numbered. Note that a frame includes 20 sub-frames, which are received successively, from the first sub-frame to the twentieth sub-frame. In FIG. 10, the operation up to the sixth sub-frame is similar to that of FIG. 8, wherein the system performs the operation of the fifth solution as set forth above, wherein n=2, m=4 and p=6. RX_ONLY 132 goes HIGH in the seventh sub-frame, thus giving a notification that only the receiving operation is performed as the wireless LAN operation. Cases where only the receiving operation is performed as the wireless LAN operation include those in which the communications state between the access point and another wireless LAN terminal is monitored and those in which the beacon signal from the access point is received. When RX_ONLY 132 is HIGH, the communications switching control section 107 performs an operation of switching only the receiving side to wireless LAN without switching the transmitting side from cellular to wireless LAN. Therefore, only RX_MODE_SEL 133 is HIGH, and TX_MODE_SEL 134 remains LOW. As a result, while the RX transceiver 115 has been switched to wireless LAN, the TX transceiver 117 continues the cellular transmission operation. Again, the communications switching control section 107 is notified by WLAN_ACT 131 that the actual wireless LAN receiving operation has been completed. Therefore, the operation is switched to cellular after 3 sub-frames, which is shorter than the original timing (after 4 sub-frames) at which the communications switching control section 107 switches to wireless LAN. Thus, the RX transceiver 115 and the TX transceiver 117 can be shared between cellular and wireless LAN.

### Embodiment 4

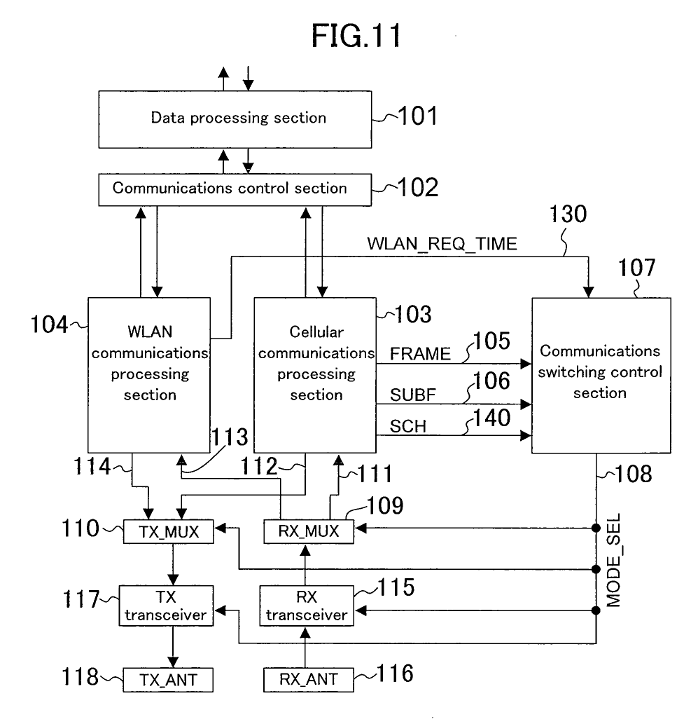

FIG. 11 is a block diagram showing a configuration of a wireless communications system according to Embodiment 4 of the present invention. Schedule information (hereinafter, “SCH”) 140 is information to be received in a sub-frame that is agreed upon in advance with the communications base station when communicating in the cellular scheme. SCH 140 represents the communications schedule, which indicates sub-frames in which data are transmitted/received. FIG. 11 is similar to FIG. 1, except that SCH 140 is added.

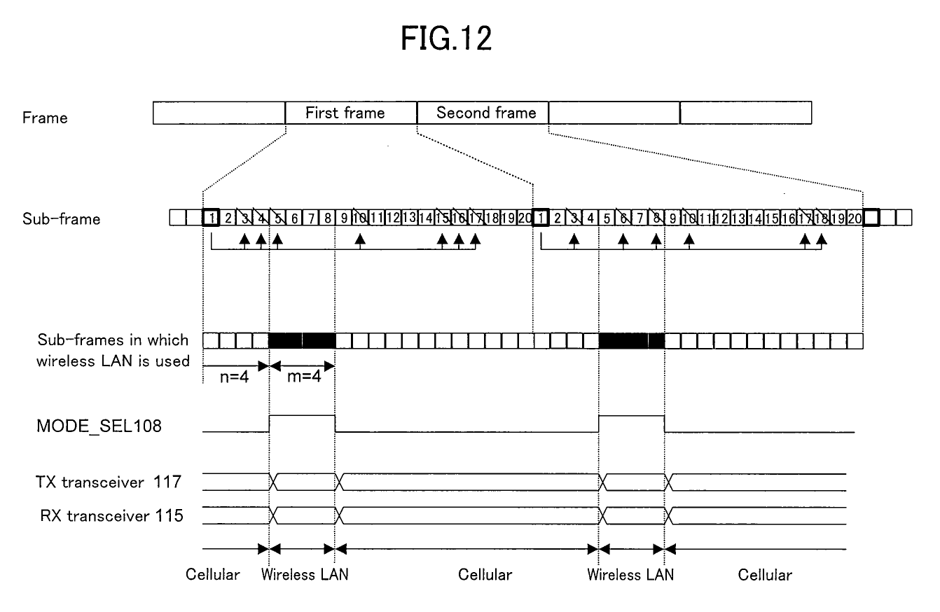

The operation of the wireless communications system having such a configuration will be described with reference to FIG. 12. FIG. 12 shows an example of the operation of the tenth solution as set forth above, wherein m=4. In FIG. 12, sub-frames are numbered. Note that a frame includes 20 sub-frames, which are received successively, from the first sub-frame to the twentieth sub-frame. The first sub-frame is a sub-frame for notifying the schedule information, and will be referred to as the “schedule sub-frame”. Sub-frames shown with the backslash symbol are those specified in the schedule sub-frame as being sub-frames in which the wireless communications system performs a communications operation. In the first frame, these sub-frames are the sub-frame numbers 3, 4, 5, 10, 15, 16 and 17. The value of n is selected to be 1 or more so that the schedule sub-frame will not be selected. Herein, n=4. Therefore, irrespective of whether it is a sub-frame for communications in the cellular scheme, the timing at which to switch to wireless LAN is located at positions where n=4 and m=4. Thus, the RX transceiver 115 and the TX transceiver 117 can be shared between cellular and wireless LAN.

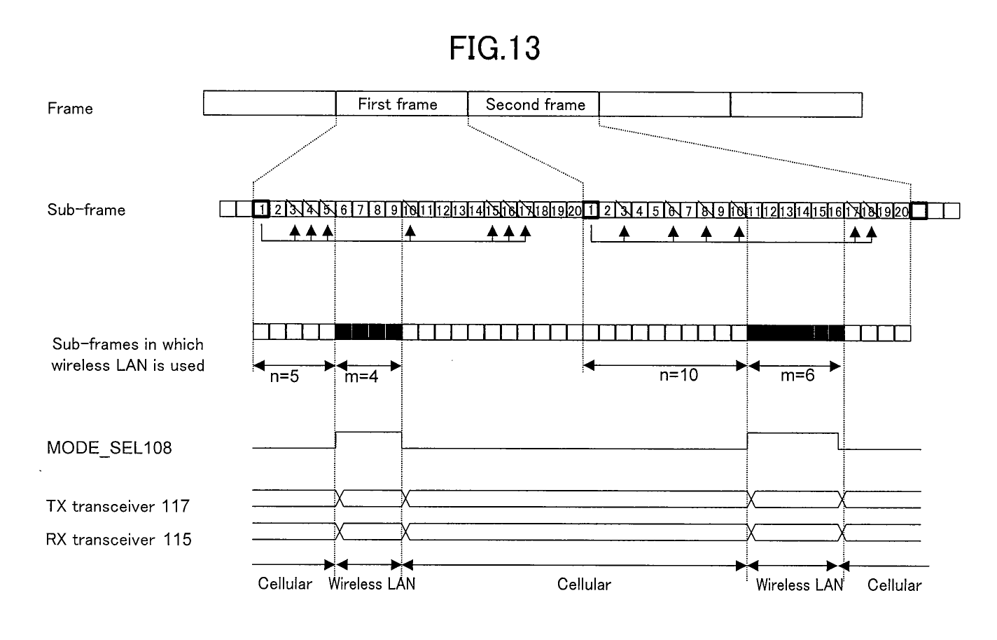

FIG. 13 shows the operation of the eleventh solution as set forth above. In FIG. 13, in the first frame, the timing at which the present wireless communications system is performing a communications operation is sub-frames 3, 4, 5, 10, 15, 16 and 17. The timing at which to switch to wireless LAN is selected to be when the present wireless communications system is not performing a communications operation, and therefore n=5 and m=4. In the second frame, the timing at which the present wireless communications system is performing a communications operation is sub-frames 3, 6, 8, 10, 17 and 18. Therefore, the timing at which to switch to wireless LAN is selected to be n=10 and m=6. Thus, the RX transceiver 115 and the TX transceiver 117 can be shared between cellular and wireless LAN.

In this example, the switching to wireless LAN is performed once in a frame, but the switching can be done a plurality of times. It is efficient if the actual time over which wireless LAN is used is determined to be the smallest amount of time with which the wireless LAN communications will not be discontinued before completion, based on the amount of time required for wireless LAN to communicate, which is input as WLAN_REQ_TIME 130.

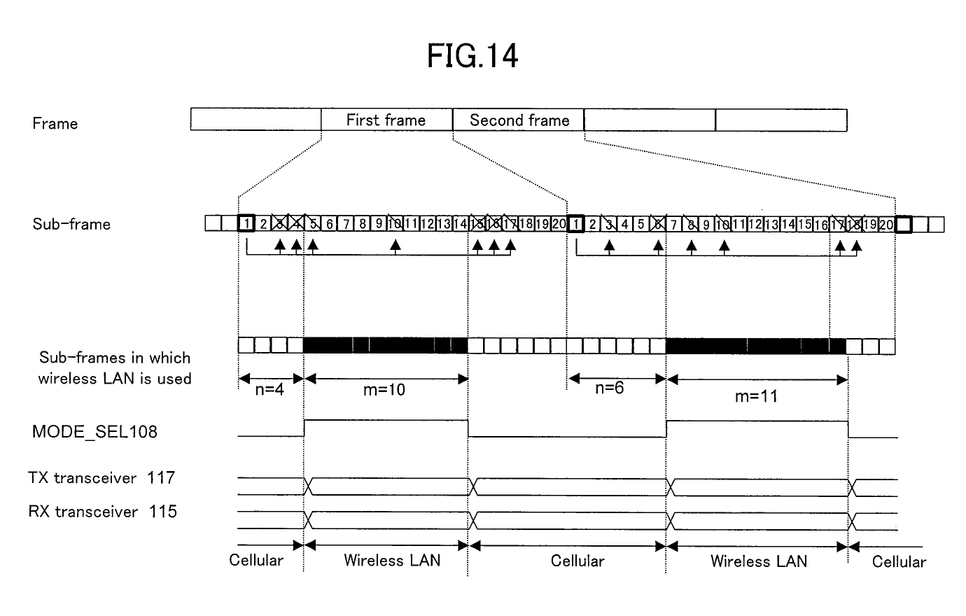

FIG. 14 shows the operation of the twelfth solution as set forth above. In FIG. 14, sub-frames in which real-time data are exchanged are specified. The backslash symbol indicates sub-frames for communicating in the cellular scheme, and the “x” symbol indicates sub-frames in which real-time data are exchanged in the cellular scheme. The “real-time data” as used herein refers to data with which the transmission delay needs to be kept small, such as sound data, music data and video data. In the first frame, while the present wireless communications system communicates in sub-frames 3, 4, 5, 10, 15, 16 and 17, and real-time data are exchanged in sub-frames 3, 4, 15 and 16. In the present embodiment, MODE_SEL 108 is controlled so that the wireless LAN scheme is used in sub-frames other than those in which real-time data are exchanged, whereby the communications switching control section 107 changes MODE_SEL 108 by selecting n=4 and m=10. In the second frame, the present wireless communications system communicates in sub-frames 3, 6, 8, 10, 17 and 18, and real-time data are exchanged in sub-frames 6 and 18. Therefore, the communications switching control section 107 changes MODE_SEL 108 by selecting n=6 and m=11. Thus, the RX transceiver 115 and the TX transceiver 117 can be shared between cellular and wireless LAN.

### Embodiment 5

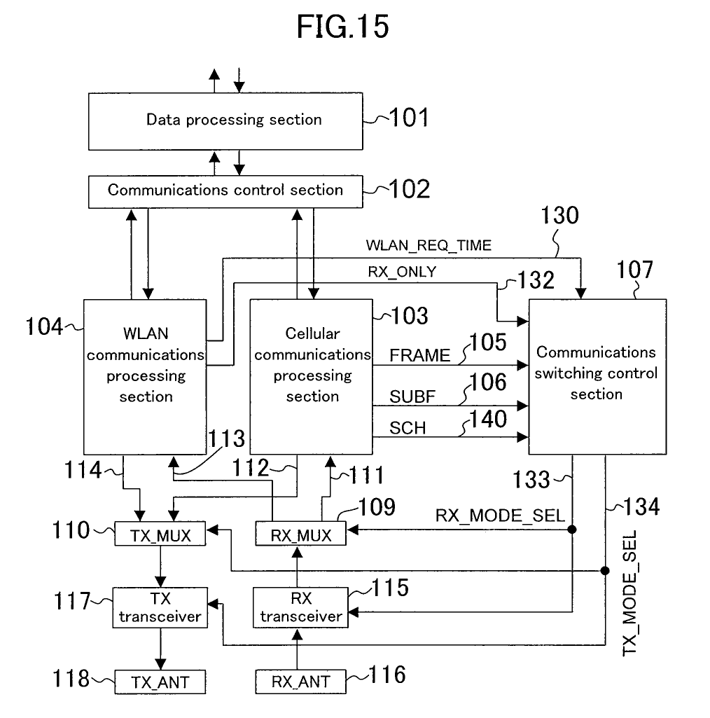

FIG. 15 is a block diagram showing a configuration of a wireless communications system according to Embodiment 5 of the present invention. The system shown in FIG. 15 is similar to that shown in the block diagram of Embodiment 4 (FIG. 11), except that RX_ONLY 132, RX_MODE_SEL 133 and TX_MODE_SEL 134 (being the functions of Embodiment 3) are added, and MODE_SEL 108 is deleted.

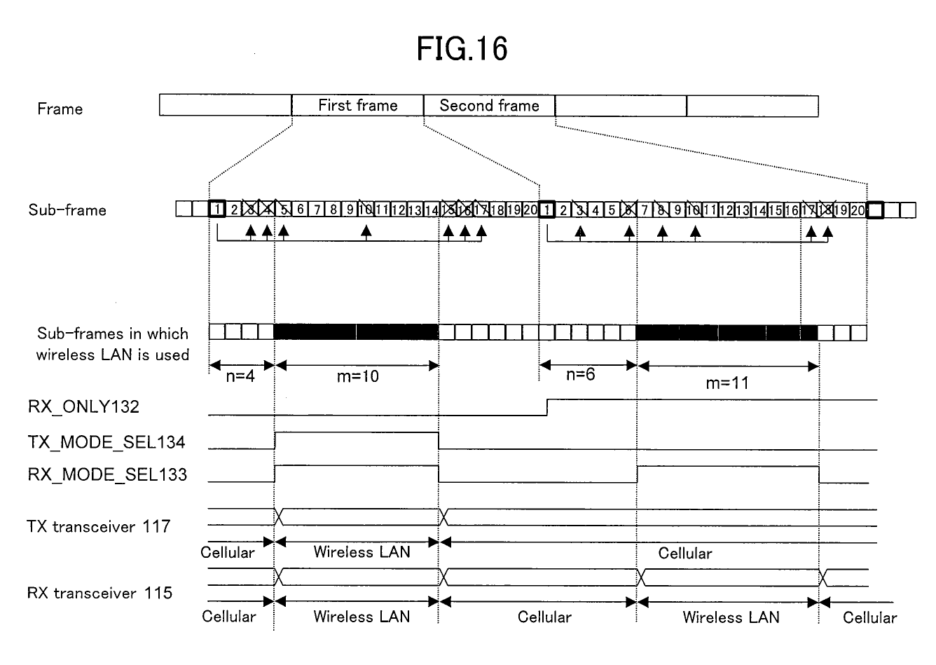

The operation of the wireless communications system having such a configuration will be described with reference to FIG. 16. In FIG. 16, RX_ONLY 132 transitions to HIGH in the second frame. Therefore, in the second frame, the WLAN communications control section 104 is only requesting the receiving operation, whereby only RX_MODE_SEL 133 transitions to HIGH while TX_MODE_SEL 134 stays LOW. The RX transceiver 115 communicates in the wireless LAN scheme while RX_MODE_SEL 133 is HIGH. On the other hand, the TX transceiver 117 continues to communicate in the cellular scheme. Thus, the RX transceiver 115 and the TX transceiver 117 can be shared between cellular and wireless LAN.

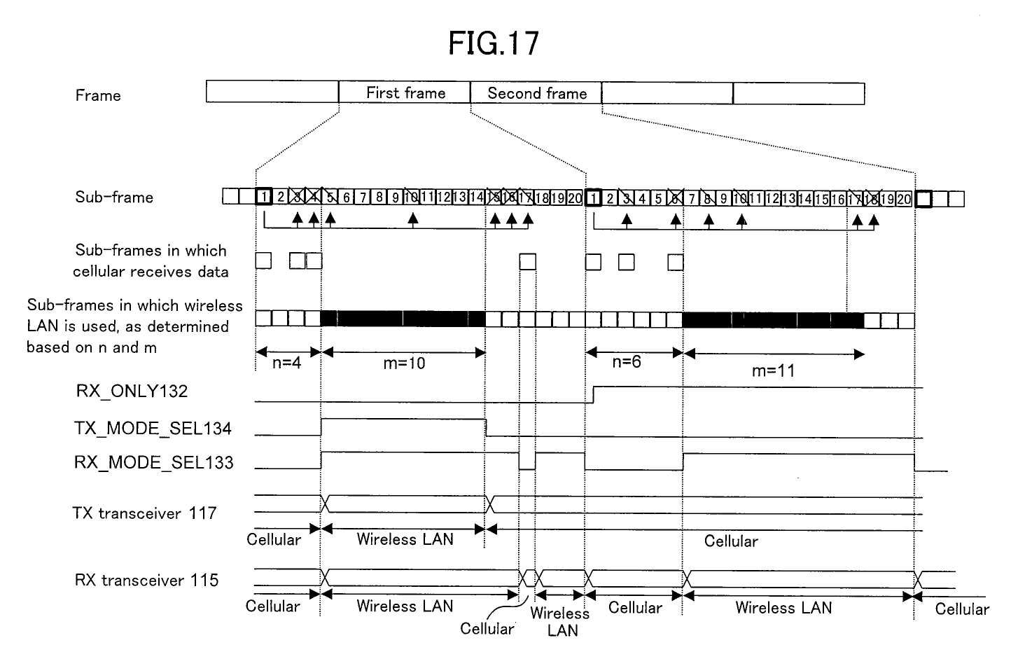

FIG. 17 shows the operation of the fourteenth solution as set forth above. Cellular schedule information indicates sub-frames in which data are received by the cellular communications processing section 103 of the present wireless communications system. In the operation of the fourteenth solution as set forth above, if there is a sub-frame in which data is not received in the cellular scheme, the RX transceiver 115 can be switched to the wireless LAN side at the timing of that sub-frame, irrespective of the values of n and m. It is indicated that sub-frames 1, 3, 4 and 17 in the first frame and sub-frames 1, 3 and 6 in the second frame are sub-frames in which the present wireless communications system receives data in the cellular communications scheme. FIG. 17 shows an example of an operation where the operation is switched to wireless LAN when no data is received in the cellular scheme for 3 consecutive sub-frames. Then, it can be seen that as compared with the operation of FIG. 16, the RX transceiver 115 is switched to wireless LAN additionally in sub-frames 15, 16, 18, 19 and 20 in the first frame and in sub-frames 18, 19 and 20 in the second frame. Thus, the RX transceiver 115 and the TX transceiver 117 can be shared between cellular and wireless LAN.

### Embodiment 6

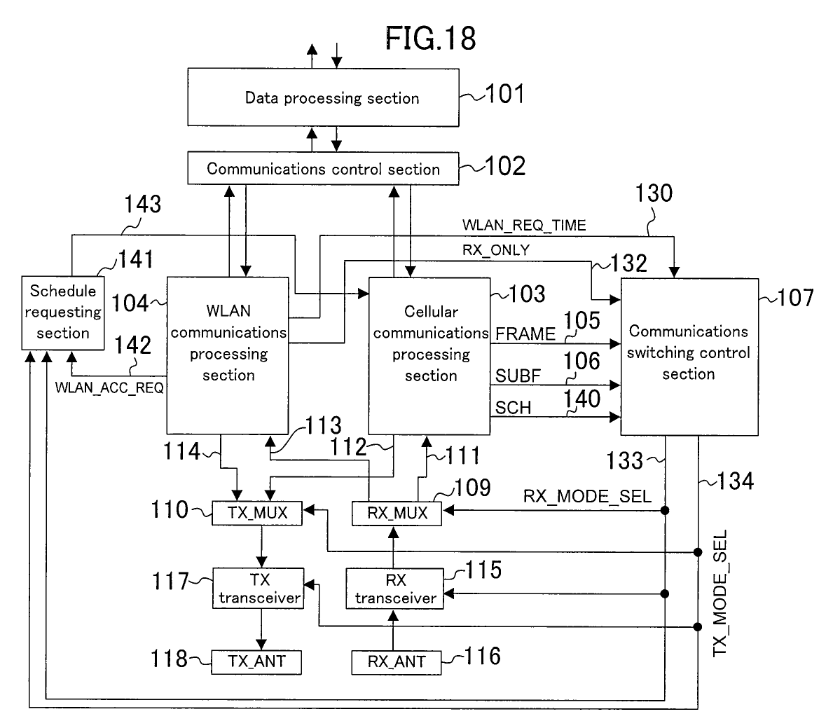

FIG. 18 is a block diagram showing a configuration of a wireless communications system according to Embodiment 6.

Reference numeral 141 denotes a schedule requesting section being a block for producing data requesting a temporary communications discontinuation to the communications base station of the cellular communications processing section 103. Reference numeral 142 denotes a wireless LAN communications request signal (hereinafter, “WLAN_ACC_REQ”), which indicates that there is a communications request in the WLAN communications processing section 104. Reference numeral 143 denotes a cellular schedule requesting signal instructing a data discontinuation to the cellular communications processing section 103. The schedule requesting section 141 activates the cellular schedule requesting signal 143 if the operation is not switched to wireless LAN over a predetermined period of time after WLAN_ACC_REQ 142 becomes active. FIG. 18 is similar to the block diagram of FIG. 15, except that the schedule requesting section 141, WLAN_ACC_REQ 142 and the cellular schedule requesting signal 143 are added. WLAN_ACC_REQ 142 is HIGH when a communications operation in the wireless LAN scheme is being requested. The schedule requesting section 141 outputs a HIGH pulse to the cellular schedule requesting signal 143 if the operation is not switched to wireless LAN, even for one sub-frame, over one frame after WLAN_ACC_REQ 142 becomes active.

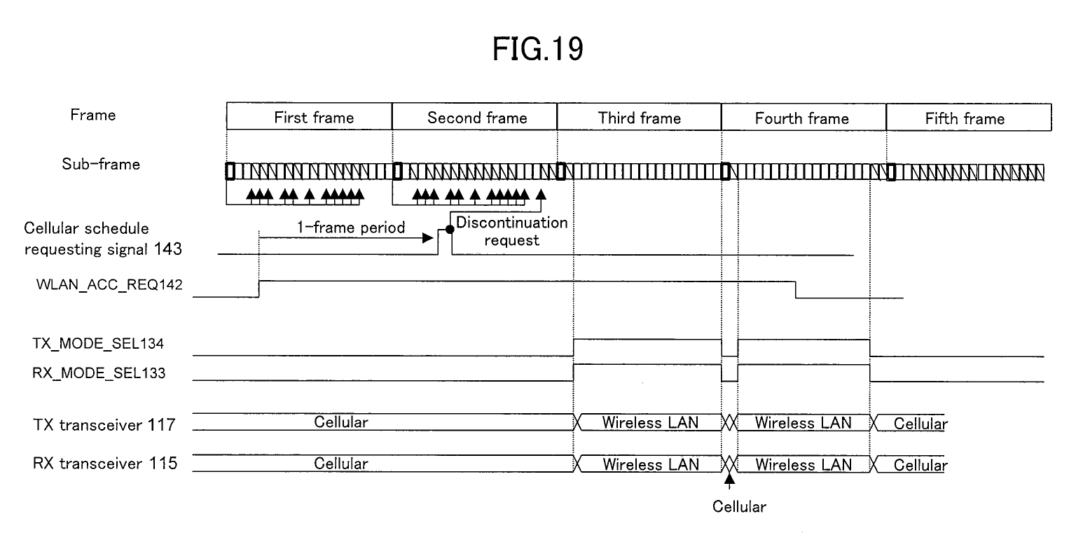

The operation of the wireless communications system having such a configuration will now be described with reference to FIG. 19. In FIG. 19, sub-frames with the backslash symbol are those in which the present wireless communications system communicates in the cellular scheme. WLAN_ACC_REQ 142 transitions to HIGH during the first frame, notifying the schedule requesting section 141 that there is a wireless LAN communications request. However, there is no sufficient break in cellular communications in the first frame and the second frame (i.e., there is no break long enough to switch to wireless LAN), and TX_MODE_SEL 134 and RX_MODE_SEL 133 are both in a state where they are not switched to wireless LAN. Therefore, the schedule requesting section 141 outputs to the cellular schedule requesting signal 143 a discontinuation request for temporarily discontinuing the cellular communications. As a result, in the second frame, data requesting a communications discontinuation is transmitted from the cellular communications processing section 103 to the communications base station. As a result, in the third frame and the fourth frame, sub-frames in which a communications operation is performed with the present wireless communications system are only those in which the schedule is delivered. As a result, based on the schedule information, the communications switching control section 107 brings RX_MODE_SEL 133 and TX_MODE_SEL 134 to HIGH so that sub-frames in the third and fourth frames are switched to wireless LAN. Then, having done necessary communications, the WLAN communications processing section 104 brings WLAN_ACC_REQ 142 down to LOW. The cellular scheme communications operation resumes in the fifth frame, but it is possible to again communicate in the wireless LAN scheme by using WLAN_ACC_REQ 142. Thus, the RX transceiver 115 and the TX transceiver 117 can be shared between cellular and wireless LAN.

The amount of time before the schedule requesting section 141 outputs the cellular schedule requesting signal 143 is preferably determined based on the system operation restrictions.

Conditions used in the description of the embodiments above are merely illustrative of the operation of the wireless communications system. For example, although the number of sub-frames in one frame is set to 20 and the length of a sub-frame is set to 0.5 ms, they may be any other suitable numbers and periods of time. Moreover, the length of a sub-frame may be either fixed or variable as long as it can be agreed upon in advance with the communications base station. A non-data signal such as a synchronization signal may be inserted between sub-frames.

The TX transceiver 117 and the RX transceiver 115 may be those of which functions can be changed reconfigurably, or those in which only those portions that can be implemented by the same circuit for both schemes are provided as shared portions. Instead of the transceiver portion, a portion of the modulating/demodulating section may be shared.

When switching the mode of operation of the TX transceiver 117 and the RX transceiver 115, a certain amount of time is required for the switching. Therefore, the timing at which the operation is switched from cellular to wireless LAN and timing at which the operation is switched from wireless LAN to cellular are determined while taking into account the amount of time required for switching.

While the embodiments above are directed to a case where the cellular scheme is used as a communications scheme capable of communications even under moving environments, other communications schemes may be used, e.g., Mobile WiMAX.

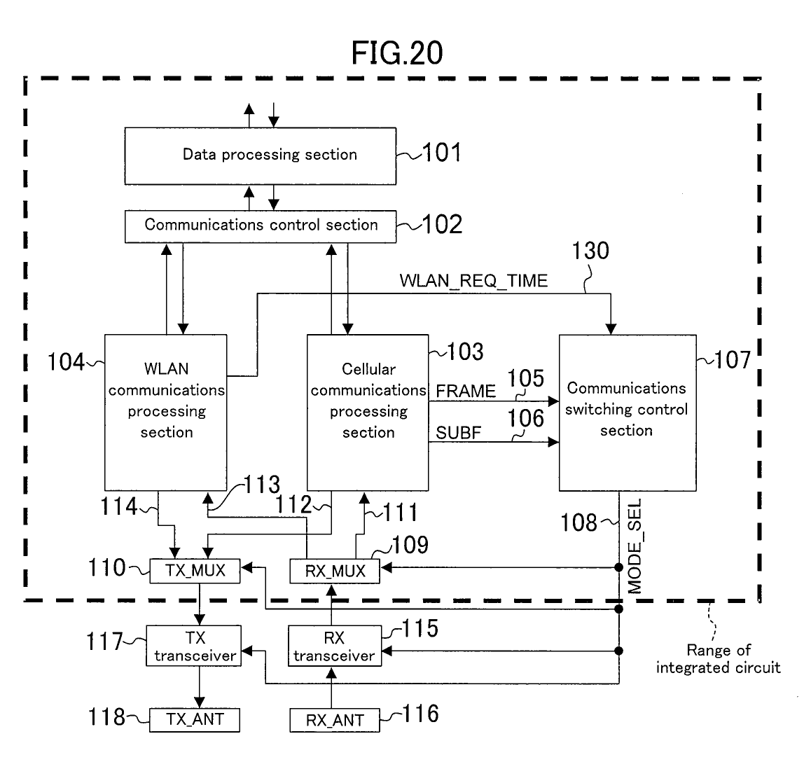

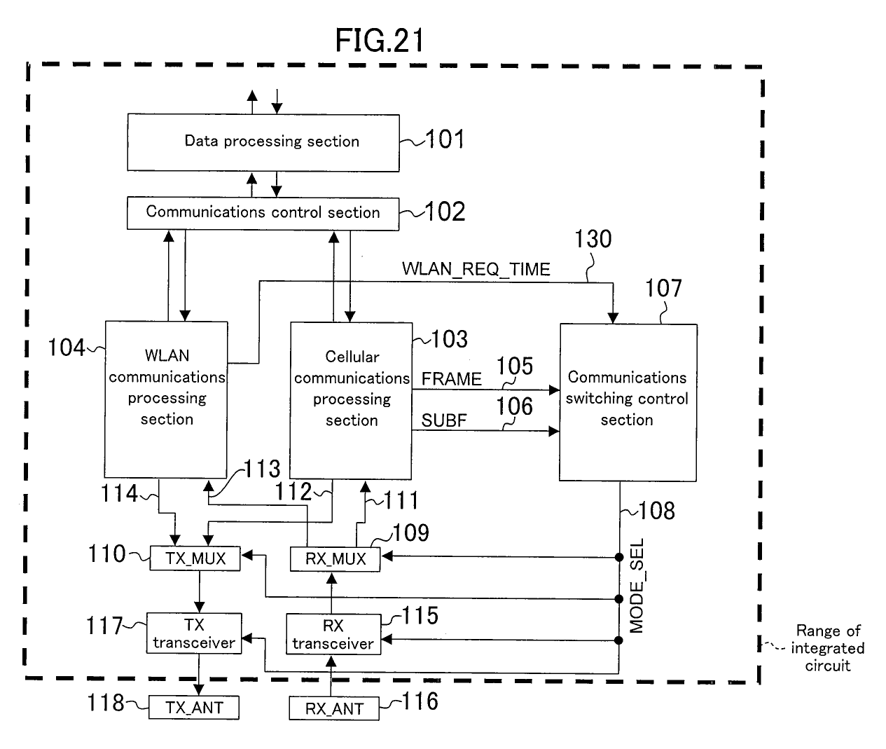

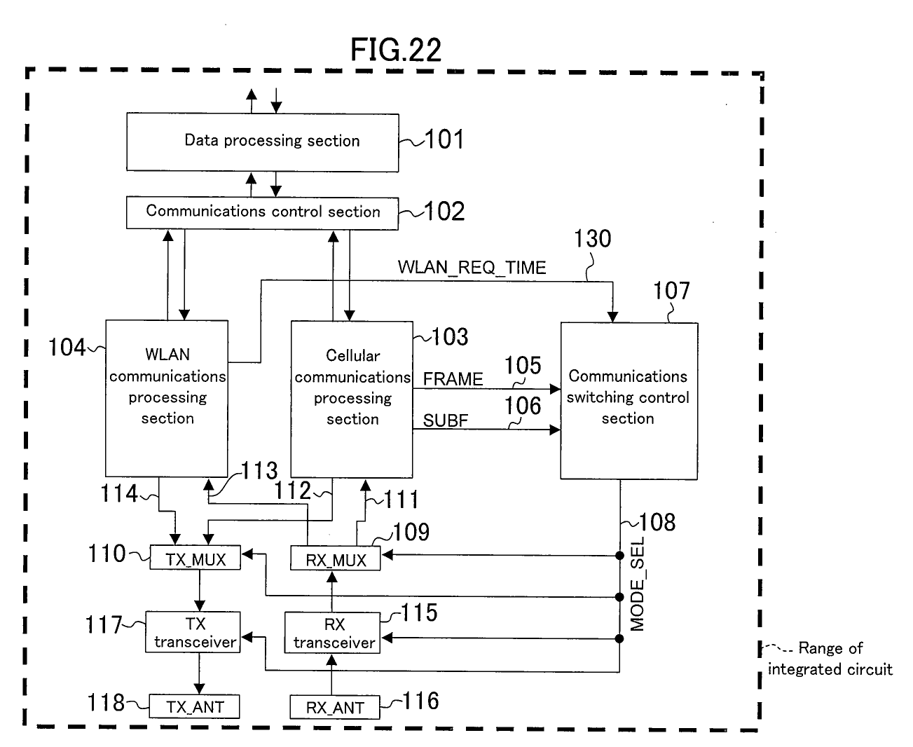

FIGS. 20 to 22 each show an example of a range of elements of the wireless communications system (FIG. 1) of Embodiment 1 of the present invention that can be implemented as an integrated circuit. FIG. 20 shows an example where elements other than the RX transceiver 115, the TX transceiver 117, the receiving antenna 116 and the transmitting antenna 118 are implemented as an integrated circuit. FIG. 21 shows an example where elements other than the receiving antenna 116 and the transmitting antenna 118 are implemented as an integrated circuit. FIG. 22 shows an example where all the elements are implemented as an integrated circuit. This similarly applies to the wireless communications systems of Embodiments 2 to 6 of the present invention (FIGS. 7, 10, 11, 15 and 18).

The wireless communications system of the present invention, in which the operation can be switched between two different wireless communications schemes, is useful in reducing the size of a wireless communications system. Moreover, an operation of switching three or more wireless communications schemes from one to another can also be realized by combining together a plurality of 2-scheme switching systems of the present invention.

What is claimed is:

1. A wireless communications system, in which some or all of a series of signal processing functions of an antenna, a high-frequency process and a modulation/demodulation process are shared between a first wireless communications scheme and a second wireless communications scheme, and a communications operation is performed by frames in the first wireless communications scheme, each frame being a collection of a plurality of sub-frames, the system comprising:
a first communications processing section for implementing a dedicated communications function that is only for the first wireless communications scheme;
a second communications processing section for implementing a dedicated communications function that is only for the second wireless communications scheme;
a shared transceiver section shared by the first communications processing section and the second communications processing section;
a scheme selection section for selectively inputting a signal from the first communications processing section or a signal from the second communications processing section to the shared transceiver section; and
a communications switching control section for indicating, to the scheme selection section, a scheme to be selected,
wherein the communications switching control section determines a switching timing based on frame and sub-frame information from the first communications processing section in an operation of switching from the first wireless communications scheme to the second wireless communications scheme or an operation of searching for a communications base station using the second wireless communications scheme.

2. The wireless communications system of claim 1, wherein:
the communications switching control section receives a frame start signal and a sub-frame start signal from the first communications processing section;
when the frame start signal is received, the communications switching control section instructs the scheme selection section to select a signal from the first communications processing section; and
when the sub-frame start signal is received n (n is a number greater than or equal to 0) times after receiving the frame start signal, the communications switching control section instructs the scheme selection section to select a signal from the second communications processing section, and when the sub-frame start signal is further received m (m is a number greater than or equal to 1) times after receiving the sub-frame start signal n times, the communications switching control section instructs the scheme selection section to select a signal from the first communications processing section.

3. The wireless communications system of claim 2, wherein the communications switching control section is such that values of n and m are fixed for all of the frame start signals.

4. The wireless communications system of claim 2, wherein the communications switching control section is such that a value of n is changed each time the frame start signal is received.

5. The wireless communications system of claim 2, wherein the communications switching control section receives, from the second communications processing section, time information representing an amount of time required for communications by the second communications processing section, and sets a value of m to be greater than the time information.

6. The wireless communications system of claim 2, wherein:
the communications switching control section receives, from the second communications processing section, a signal indicating that a communications operation by the second communications processing section has been completed; and
when a communications operation by the second communications processing section has been completed, the communications switching control section instructs the scheme selection section to stop selecting a signal from the second communications processing section and to select a signal from the first communications processing section.

7. The wireless communications system of claim 1, wherein:
the communications switching control section receives a frame start signal and a sub-frame start signal from the first communications processing section;
when the frame start signal is received, the communications switching control section instructs the scheme selection section to select a signal from the first communications processing section;
when the sub-frame start signal is received n (n is a number greater than or equal to 0) times after receiving the frame start signal, the communications switching control section instructs the scheme selection section to select a signal from the second communications processing section;
each time the sub-frame start signal is received p (p is a number greater than or equal to 0) times after instructing the scheme selection section to select a signal from the second communications processing section, the communications switching control section repeatedly instructs the scheme selection section to select a signal from the second communications processing section; and
when the sub-frame start signal is received m times after instructing the scheme selection section to select a signal from the second communications processing section, the communications switching control section instructs the scheme selection section to select a signal from the first communications processing section.

8. The wireless communications system of claim 7, wherein the communications switching control section receives, from the second communications processing section, time information representing an amount of time required for communications by the second communications processing section, and sets a value of m to be greater than the time information.

9. The wireless communications system of claim 7, wherein:
the communications switching control section receives, from the second communications processing section, a signal indicating that a communications operation by the second communications processing section has been completed; and
when a communications operation by the second communications processing section has been completed, the communications switching control section instructs the scheme selection section to stop selecting a signal from the second communications processing section and to select a signal from the first communications processing section.

10. The wireless communications system of claim 1, wherein:
the communications switching control section is capable of instructing the scheme selection section independently for reception and for transmission; and
if the second communications processing section is to perform only a receiving operation, the communications switching control section instructs the scheme selection section to select the second communications processing section only for a receiving side and select the first communications processing section for a transmitting side.

11. The wireless communications system of claim 1, wherein the first wireless communications scheme is a mobile communications scheme capable of communications over a wide area.

12. The wireless communications system of claim 1, wherein the second wireless communications scheme is a wireless LAN scheme capable of communications over a small area.

13. An integrated circuit for wireless communications system, wherein the first communications processing section, the second communications processing section, the scheme selection section and the communications switching control section of claim 1 are formed on the same chip.

14. An integrated circuit for wireless communications system, wherein the first communications processing section, the second communications processing section, the shared transceiver section, the scheme selection section and the communications switching control section of claim 1 are formed on the same chip.

15. A wireless communications system, in which some or all of a series of signal processing functions of an antenna, a high-frequency process and a modulation/demodulation process are shared between a first wireless communications scheme and a second wireless communications scheme, and a communications operation is performed by frames in the first wireless communications scheme, each frame being a collection of a plurality of sub-frames, the system comprising:
a first communications processing section for implementing a dedicated communications function that is only for the first wireless communications scheme;
a second communications processing section for implementing a dedicated communications function that is only for the second wireless communications scheme;
a shared transceiver section shared by the first communications processing section and the second communications processing section;
a scheme selection section for selectively inputting a signal from the first communications processing section or a signal from the second communications processing section to the shared transceiver section; and
a communications switching control section for indicating, to the scheme selection section, a scheme to be selected,
wherein the communications switching control section determines a switching timing based on frame and sub-frame information from the first communications processing section and schedule information sent from a communications base station of the first communications processing section in an operation of switching from the first wireless communications scheme to the second wireless communications scheme or an operation of searching for a communications target station using the second wireless communications scheme.

16. The wireless communications system of claim 15, wherein:
the communications switching control section receives a frame start signal and a sub-frame start signal from the first communications processing section;
when the frame start signal is received, the communications switching control section instructs the scheme selection section to select a signal from the first communications processing section; and
when the sub-frame start signal is received n (n is a number greater than or equal to 0) times after receiving the frame start signal, the communications switching control section instructs the scheme selection section to select a signal from the second communications processing section, and when the sub-frame start signal is further received m (m is a number greater than or equal to 1) times after receiving the sub-frame start signal n times, the communications switching control section instructs the scheme selection section to select a signal from the first communications processing section.

17. The wireless communications system of claim 16, wherein based on the schedule information, the communications switching control section determines values of n and m to be values other than a timing of a communications operation using the first communications processing section.

18. The wireless communications system of claim 16, wherein based on the schedule information, the communications switching control section determines values of n and m to be values other than a timing of communicating real-time data using the first communications processing section.

19. The wireless communications system of claim 15, wherein:
the communications switching control section is capable of instructing the scheme selection section independently for reception and for transmission; and
if the second communications processing section is to perform only a receiving operation, the communications switching control section instructs the scheme selection section to select the second communications processing section only for a receiving side and select the first communications processing section for a transmitting side.

20. The wireless communications system of claim 15, wherein:
the communications switching control section is capable of instructing the scheme selection section independently for reception and for transmission; and
based on the schedule information, the communications switching control section instructs the scheme selection section to select the second communications processing section only for a receiving side, irrespective of the values of n and m, at a timing at which a receiving operation is not performed by using the first communications processing section.

21. The wireless communications system of claim 15, further comprising a schedule requesting section for requesting a communications base station of the first communications processing section for a schedule of temporarily discontinuing a communications operation using the first communications processing section, if a communications operation by the second communications processing section is needed.

22. The wireless communications system of claim 18, wherein the real-time data is sound data or video data.

23. The wireless communications system of claim 15, wherein the first wireless communications scheme is a mobile communications scheme capable of communications over a wide area.

24. The wireless communications system of claim 15, wherein the second wireless communications scheme is a wireless LAN scheme capable of communications over a small area.

25. An integrated circuit for wireless communications system, wherein the first communications processing section, the second communications processing section, the scheme selection section and the communications switching control section of claim 15 are formed on the same chip.

26. An integrated circuit for wireless communications system, wherein the first communications processing section, the second communications processing section, the shared transceiver section, the scheme selection section and the communications switching control section of claim 15 are formed on the same chip.
